(19) United States
(12) Patent Application Publication
(10) Pub. No.: US 2022/0286364 A1
(43) Pub. Date: Sep. 8, 2022

(54) SYSTEMS AND METHODS FOR SIMULATING NETWORK PATH BEHAVIORS

(71) Applicant: Microsoft Technology Licensing, LLC, Redmond, WA (US)

(72) Inventors: Sachin ASHOK, Kerala (IN); Venkata Sai Surya Subramanyam DUVVURI, Hyderabad (IN); Nagarajan NATARAJAN, Bengaluru (IN); Venkata N. PADMANABHAN, Bengaluru (IN); Sundararajan SELLAMANICKAM, Bengaluru (IN); Johannes Ernst GEHRKE, Bellevue, WA (US)

(21) Appl. No.: 17/192,638

(22) Filed: Mar. 4, 2021

(51) Int. Cl. H04L 12/24; H04L 12/26

(52) U.S. Cl. CPC H04L 41/147; H04L 41/145; H04L 43/14; H04L 43/0852

(57) ABSTRACT

The present disclosure relates to systems, methods, and computer-readable media for training and implementing network behavior model on a network simulator to accurately predict delays in communications transmitted between a sender and receiver of a communication network. For example, systems disclosed herein involve training a network behavior model to determine various behavior parameters that may be used to configure a network simulator trained to emulate certain network behaviors while simulating a network path between a sender and receiver. The systems disclosed herein further involve implementing the network simulator to predict delays that accurately represent real-life conditions of the communication network in an effort to accurately predict delays in communications.

### BACKGROUND

Recent years have seen a significant increase in the use of computing devices to process and communicate data. For example, any number of computing devices may communicate with one another over a communication network by transmitting and/or receiving packets of data between multiple devices within a hierarchy of the communication network. As communication networks grow in size and complexity, it is often difficult to predict or evaluate how packets of data will travel between devices of communication networks. Indeed, implementing updates or changes to applications and/or communication protocols may cause unexpected delays or failed communications.

While network testing systems may attempt to predict how a network may affect how an application communicates over a communication network, conventional systems and techniques that involve testing how network behavior affects applications suffer from a number of drawbacks and difficulties. For example, many testing systems implement A/B testing techniques by testing treatment (i.e., B) against a control (i.e., A) prior to rolling it out to real users. While A/B testing provides real data and an accurate depiction of how a portion of devices and/or applications may perform with respect to devices on a communication network, if the application and/or update results in a negative experience, individuals affected by the A/B testing may associate the negative experience with a provider application. Moreover, because A/B testing is typically done on very few individuals to mitigate or otherwise reduce the scale of negative user experiences, A/B testing is typically done over a long period of time to ensure that the data gathered is statistically significant and therefore indicative of how the application and/or update(s) will affect or be affected by network communications.

Other network testing systems may attempt to use conventional network testbeds. These conventional network testbeds, however, often lack the scale and reach to be representative of actual network behavior. Indeed, as communication networks continue to grow at an incredible rate, and as network behavior evolves, many conventional testing environments fail to accurately simulate or emulate how a modern communication network will actually behave. As a result, using conventional network testbeds often provides overly ideal or less than accurate behavior predictions and ultimately fails to provide accurate estimations for how an application, update, or protocol will affect performance on a modern communication network.

These and other problems exist in evaluating behaviors and performance of new and updated applications and protocols in realistic network settings.

### BRIEF DESCRIPTION OF THE DRAWINGS

FIG. 1 illustrates an example environment showing a training phase and simulation phase for a network simulation system in accordance with one or more embodiments.

FIG. 2 illustrates an example computing device(s) including systems implemented thereon to facilitate simulating a network path in accordance with one or more embodiments.

FIGS. 3A-3B illustrates an example implementation of a simulation system and associated simulation results in accordance with one or more embodiments.

FIG. 4 illustrates an example implementation of training a simulation system that includes a machine learning model in accordance with one or more embodiments.

FIGS. 5A-5B illustrate an example implementation of a simulation system including the machine learning model and associated simulation results in accordance with one or more embodiments.

FIG. 6 illustrates an example series of acts for implementing a simulation system in accordance with one or more embodiments.

FIG. 7 illustrates an example series of acts for implementing a simulation system including a machine learning model in accordance with one or more embodiments.

FIG. 8 illustrates certain components that may be included within a computer system.

### DETAILED DESCRIPTION

The present disclosure relates to systems and methods for training and implementing a network simulation system to accurately emulate behavior of an application on a network by simulating conditions of a network path between endpoints (e.g., senders and receivers) of a communication network. For example, as will be discussed in further detail below, systems described herein collect real data from network traces to train a network simulation system to simulate various characteristics of a network path between a sender and a receiver of one or more communication packets (or simply “packets”). In particular, and as will be discussed in further detail below, the systems described herein can model various network parameters and characteristics that enable testing an application (e.g., an application update, a communication protocol) to evaluate how the application will behave or otherwise perform on a communication network under a variety of network conditions.

As a first example, one or more embodiments are directed to systems and methods that model a network path between a sender and receiver of a communication network. In this example, a system may identify a sender and a receiver within a communication network. The sender and receiver may be associated with respective sets of user and/or device attributes (or simply “attributes”). The system may further receive or otherwise identify behavior parameters for a network path between the sender and receiver. These behavior parameters may include a variety of network behaviors such as estimated cross traffic, bandwidth, delay, and/or buffer size. The system may apply the network behavior information to a simulation configuration of a network path simulator that is trained to emulate various network behavior(s). The system may further apply the network path simulator to a packet time series to generate an estimated output (e.g., an estimated packet delay, an estimated packet drop rate) for the packet time series when communicated via a network path between the sender and receiver.

As a second example, which may include many of the same features and functionality as the first example above, one or more embodiments described herein are directed to systems and methods that involve a network path simulator that incorporates a machine learning model. For example, a system may receive a collection of packet traces including trace information for a plurality of communications between a set of senders and corresponding set of receivers. The system may additionally train a network path machine learning model (or simply “network path model”) to simulate network path behaviors affecting communications between a given sender and receiver having a corresponding set of user and/or device attributes. The system may further apply the network path model to a packet time series associated with a sender to generate an estimated output for the packet time series via a network path between the sender and a receiver.

The present disclosure provides a number of practical applications that provide benefits and/or solve problems associated with modeling network behavior and accurately evaluating delays and/or successful delivery of packets communicated between senders and receivers of a communication network. Some examples of these applications and benefits are discussed below.

For example, systems described herein incorporate features and functionalities that provide more accurate evaluations for estimating an output of communications between senders and receivers of a communication network. For instance, one or more embodiments of a network simulation system estimate a variety of parameters for a network path based on real data obtained from packet traces in conjunction with communications between senders and receivers of a network environment. This consideration of real data facilitates configuring a network simulation engine based on historical behaviors, thus enabling a network simulation system to realistically emulate various behaviors from the communication network. As will be discussed in further detail below, features and functionalities described herein involve sampling data from a collection of network traces to identify behavior parameters including, by way of example and not limitation, cross traffic, communication bandwidths, communication delays, and buffer sizes.

In addition to considering behavior parameters calculated from sampled data, one or more embodiments of the network simulation system may consider possibly more complex machine-learned parameters learned via a machine learning training process. In particular, a training system may learn various network behaviors that are unrealistic to calculate or sample such as a reordering of network packets from a packet time series, variable bandwidth over durations of time, and random loss of network packets. In one or more embodiments, the network simulation system may consider a combination of calculated network behaviors (e.g., based on sampled data) and machine-learned behaviors.

By training and implementing a network simulation system in accordance with one or more embodiments described herein, systems described herein can avoid some of the drawbacks of AB testing techniques. For example, the network simulation system can accurately evaluate a positive or negative impact on a networking application or protocol, without causing users to experience some of the potentially negative impacts associated with upgrading applications and/or protocols on a network. In addition, by testing new applications, updates, and protocols in accordance with one or more embodiments described herein, the network simulation system can facilitate faster rollout of new applications, application updates, and new communication protocols.

As illustrated in the foregoing discussion, the present disclosure utilizes a variety of terms to describe features and advantages of one or more embodiments of the network simulation system described herein. For example, as used herein, a “communication network” or “network environment” may refer to any collection of computing devices and applications thereon that are configured to communicate via one or more platforms. For example, a communication network may include one or multiple networks that use any communication platform or technology for transmitting data. A communication network may include the Internet or other data link that enables transport of electronic data (e.g., network packets) between respective devices of the communication network.

As used herein a “network path” may refer to a mechanism whereby one or more network packets are communicated between two devices of a communication network. For example, a network path may refer to a path of multiple devices along which network packets of a communication session is communicated from an origin (e.g., a sender) to a destination (e.g., a receiver). As used herein, a network path may refer to a specific or fixed path between a receiver and a sender. Alternatively, a network path may refer to a number of different paths that network packets of a packet time series use throughout the duration of a communication session. As will be discussed below, one or more systems described herein can model a network path as a single bottleneck path between a sender and a receiver.

As used herein, a “packet time series” includes any number of network packets that are communicated between devices of a communication network. In one or more embodiments described herein, a packet time series includes a plurality of network packets that are communicated from a sender to a receiver over a single or multiple communication sessions. In one or more embodiments, a packet time series refers to communication packets that are sent or received using a specific application and/or using a specific protocol or that are otherwise associated with a corresponding set of communication attributes (e.g., user or device attributes, application attributes, protocol attributes).

As noted above, one or more embodiments of the network simulation system may emulate network behavior based on a number of simulated conditions for communications between a given sender and receiver. As used herein, a “sender” may refer to any device and/or application from which a communication originates. Similarly, a “receiver” may refer to any device and/or application for which a communication is intended. Thus, in one or more embodiments, a sender and receiver may refer to a pair of devices, applications, or combination of device and/or application from which a communication originates and for which the communication is intended (e.g., independent of whether the communication arrives at the target destination).

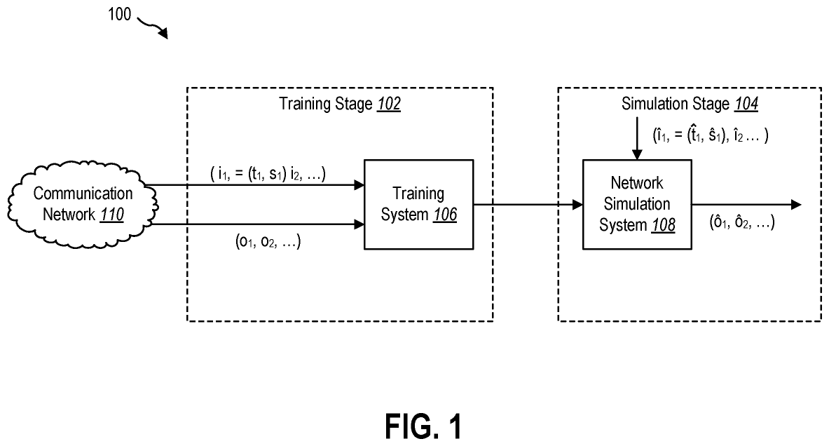

Additional detail will now be provided regarding systems for training and implementing a network behavior model in accordance with one or more embodiments. For example, FIG. 1 illustrates an example workflow 100 showing a training phase 102 and a simulation phase 104 in which a training system 106 and a network simulation system 108 can be implemented. In particular, the workflow 100 in FIG. 1 shows an example implementation in which network behavior for a communication network 110 can be obtained and used to evaluate subsequent network behavior for one or more network paths of the communication network 110.

For example, as shown in FIG. 1, a training system 106 can receive information from a collection of packet traces between a set of senders and a corresponding set of receivers. As shown in FIG. 1, each of the packet traces may include user attributes (e.g., sender or receiver information) and timing information (e.g., timestamp information for a sender or receiver). The packet traces may include additional metadata associated with the receiver/sender, application data, protocol data, or any other information associated with a particular communication between a sender and receiver.

As shown in FIG. 1, the packet time series may include a first packet time series for a set of senders (denoted as i₁, i₂, . . . ). The first packet time series may include any number of network packets associated with any number of senders. As further shown, each of the packets may include timing information (e.g., a timestamp associated with when the packet was transmitted) and one or more sender attributes. As used herein, a sender attribute may refer to any information about a sender of a packet. For example, a sender attribute may refer to information about a sender device, an application in use by the sender device to send the packet, a communication protocol in use by the sender and/or the communication network 110 for transmitting the packet from the sender to the receiver, and any other information about the sender that may be used by the training system 106 to identify trends and learn network path behavior between the senders and receivers.

As further shown in FIG. 1, the packet time series may include a second packet time series for a set of receivers (denoted as o₁, o₂, . . . ). The second packet time series may include any number of network packets associated with any number of receivers. As shown in FIG. 1, each of the packets may include timing information (e.g., a timestamp associated with when the packet was received) and one or more receiver attributes. As used herein, a receiver attribute may refer to any information about a receiver of a packet. For example, a receiver attribute may include information about a receiver device, an application in use by the receiver device to receive or present content of the packet, a communication protocol in use by the receiver and/or the communication network 110 for receiving the packet at the receiver from the sender, and any other information about the receiver that may be used by the training system 106 to identify trends and learn network path behaviors between the senders and receivers.

As noted above, the sender(s) and receiver(s) may be associated with corresponding sets of attributes, which may include a variety of features and characteristics descriptive of the devices and/or applications used by an associated sender or receiver. Some non-limiting examples of these various attributes may include type of connectivity of a sender or receiver (e.g., wired, WiFi, cellular, etc.) an Internet service provider (ISP) identifier, and a location (e.g., India, United States, etc.). As will be discussed in further detail below, these attributes enable systems described herein to segregate data as well as build and use more targeted models. As an example in accordance with one or more embodiments described herein, a model may be built specifically for communication paths emanating from cable broadband connected nodes in Europe.

In addition to information about the respective receiver(s) and sender(s), the packet traces may include mapping information between corresponding packet traces. For example, the first set of packet traces associated with the senders may include a destination address (e.g., a sender address) corresponding to an internet protocol (IP) address or device address for the receiver. Similarly, the second set of packet traces associated with the receivers may include address information correlating the packet time series with corresponding packet information for the senders.

As noted above, the training system 106 can train a network behavior model to predict or otherwise evaluate network path behavior between a given sender and receiver of the communication network 110. For example, the training system 106 may analyze information from the first and second sets of packet time series for the plurality of senders and receivers of the communication network 110. The training system 106 may train the network behavior model in a variety of ways. In one or more embodiments, the training system 106 samples select packets from the packet time series to identify trends or calculate behavior parameters for selectively identified subsets of packet time series data. In addition, or as an alternative, the network behavior model refers to a machine learning model based on learned behavior data from the collection of time series packets collected at the training system 106 and used as training data in training and refining machine learned algorithms of the network behavior model. Additional information in connection with these example models will be discussed below.

In both examples of calculated model and/or the machine learning model, the network simulation system 108 can receive the network behavior model and apply the network behavior model to a simulator configuration of the network simulation system 108. In particular, the network simulation system 108 may apply the network behavior model to emulate behaviors of a network path between a sender and a receiver. As will be discussed in further detail below, the network simulation system 108 may cause a simulation engine to emulate different network behaviors (e.g., network behavior parameters). For example, the network simulation system 108 may cause the simulation engine to calculated network path parameters such as cross traffic, bandwidth, packet delay, and buffer size. In addition, or as an alternative, the network simulation system 108 can cause the simulation engine to emulate machine learned network path parameters such as packet reordering, variable bandwidth over time, and random packet loss.

As shown in FIG. 1, the network simulation system 108 can receive a time series input including any number of input packets associated with a set of senders. As shown in FIG. 1, the time series input may include any characteristics of the senders (e.g., device specifications, application information, sender location, etc.) as well as timing information for the input packets. The network simulation system 108 may apply the simulation engine in accordance with the simulation configuration to the input packets to predict a time series output for a set of receivers.

The above workflow 100 may be implemented in a variety of computing environments. For example, in one or more embodiments, the training stage 102 and the simulation stage 104 may be implemented on different computing devices or different systems of devices. Alternatively, in one or more embodiments, the training stage and simulation stage may be performed on a single computing device or on a single computing platform, such as a training system 106 and simulation system 108 both implemented on a server device or on multiple server devices of a cloud computing system.

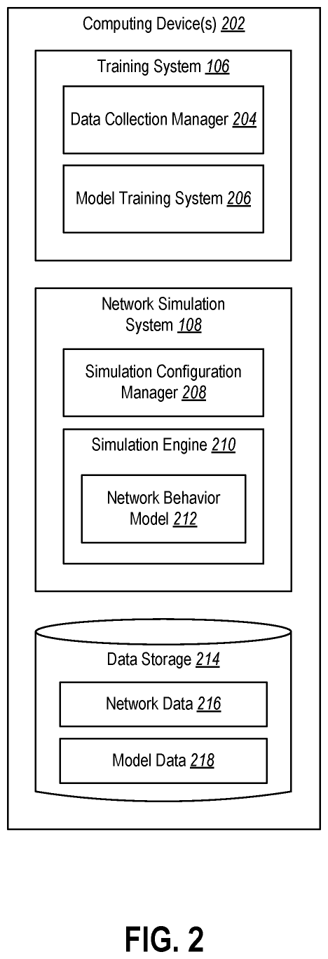

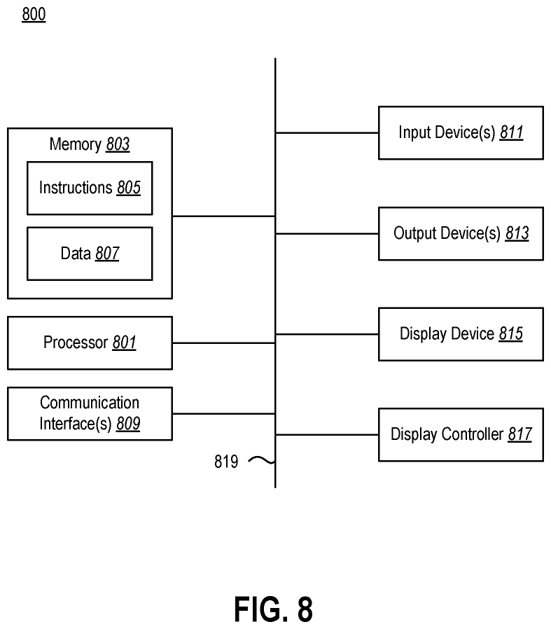

FIG. 2 illustrates an example implementation including an example computing device 202. As noted above, the computing device(s) 202 may refer to a single or multiple computing devices. The computing device(s) 202 may refer to various types of computing devices. As an example, the computing device(s) 202 may include one or more client devices, such as a mobile device (e.g., smartphone, tablet, laptop) or a non-mobile device (e.g., desktop computer, private server device). In addition, or as an alternative, the computing device(s) 202 may refer to one or more server devices, such as one or more server nodes implemented on a cloud computing system. The computing device(s) 202 may include features and functionalities described in further detail below in connection with FIG. 8.

As shown in FIG. 2, the computing device(s) 202 may include a training system 106 having similar features and functionalities discussed above in connection with the training system 106 of the training stage 102 illustrated in FIG. 1. As further shown, the computing device(s) 202 may include a network simulation system 108 having similar features and functionalities discussed above in connection with the network simulation system 108 of the simulation stage 104 illustrated in FIG. 1. As noted above, each of the respective systems 106, 108 (and/or subcomponents thereon) may be implemented on the same or different devices.

The training system 106 may include a data collection manager 204. In one or more embodiments, the data collection manager 204 collects data associated with communications that occur between senders and receivers of the communication network 110. For example, the data collection manager 204 can collect packet traces including trace information for any number of communications between senders and corresponding receivers of the communication network 110. As noted above, the trace information may include any information associated with a sender and/or receiver including, by way of example, an application being used to transmit data, a communication protocol in use by various senders/receivers, and timing information associated with when a communication is sent and/or received by a respective device.

The data collection manager 204 can collect communication data associated with a variety of network communications. For example, the data collection manager 204 may collect trace information from packet traces for communication sessions involving a larger group of users and/or direct communication sessions between individual users. The data collection manager 204 may additionally collect communication data associated with different communication protocols or communications originating and received using a variety of applications on respective computing devices.

In addition to generally collecting communication data, the data collection manager 204 can further categorize or group the data in a variety of ways. For example, the data collection manager 204 can tag or otherwise associate communications with various characteristics. For instance, a communication may be associated with a particular geography, an Internet protocol (IP) address, a communication protocol, an application, a connection speed, or any other characteristic associated with a sender, receiver, or the communication itself. In one or more embodiments, the data collection manager 204 groups the communication data by respective characteristics. In one or more embodiments, the data collection manager 204 simply tags or associates the communication data with respective characteristics.

In one or more embodiments, the data collection manager 204 categorizes and/or stores the communication data by communication sessions. For example, where a communication session includes a call (e.g., audio call, video call) between one or more senders and receivers that involves transmission of many communication packets, the data collection manager 204 can group or otherwise associate the packets for a communication session with one another. The data collection manager 204 can further track timing information for the respective packets. As will be discussed in further detail below, this grouping and categorization of the communication packets enables a network simulation system 108 to effectively simulate or recreate a communication session with one or more modified characteristics in a way that enables the network simulation system 108 to diagnose problems and/or modify one or more network behaviors or communication characteristics of the communication session.

As further shown in FIG. 1, the training system 106 includes a model training system 206. The model training system 206 can train a model and/or algorithms to simulate certain behaviors of the communication network 110. In particular, and as will be discussed below, the model training system 206 can train a network behavior model 212 to simulate a variety of behaviors for a network path between a sender and corresponding receiver of a communication.

In one or more embodiments, the model training system 206 generates a network behavior model 212 including one or more algorithms based on sampled data from the packet traces. In one or more embodiments, the model training system 206 generates a network behavior model 212 including a machine learning model that learns more complex behaviors of the communication network 110 based on any number of signals associated with respective packet traces for corresponding senders and receivers on the communication network 110. In both cases, the model training system 206 generates a network behavior model 212 based on real data that provides a realistic representation of certain network behaviors that affect communication of data between respective devices on the communication network 110.

As noted above, the model training system 206 can model a variety of different network behaviors. For instance, in one or more embodiments, the model training system 206 facilitates a network behavior model 212 that calculates network behaviors based on sampled traces including, by way of example, a bandwidth of a network path, a delay of the network path, a buffer size of the network path, and/or a cross traffic model for the network path. In addition, or as an alternative, in one or more embodiments, the model training system 206 facilitates a network behavior model 212 including a machine learning model that determines a variety of machine-learned behaviors including, by way of example, reordering of network packets, variable bandwidth over time, and random loss of network packets from a packet time series.

In one or more embodiments, the model training system 206 trains a network behavior model capable of modeling a combination of sampled and machine learned behaviors. For example, in one or more embodiments, the network behavior model may be trained to emulate one or more network behaviors such as variable bandwidth and random loss while also emulating an estimated cross traffic load or other metric illustrative of cross traffic. As will be discussed in further detail below, this combination of behaviors can be particularly useful where a machine learning model erroneously attributes certain observed trends to observed inputs (e.g., erroneously inferring or learning that a low delay environment corresponds to a high sending rate).

As shown in FIG. 2, a network simulation system 108 may include a simulation configuration manager 208. The simulation configuration manager 208 may perform various acts related to establishing a simulation configuration to use by the simulation engine 210 in accordance with one or more embodiments. For example, in one or more embodiments, the simulation configuration manager 208 selects a set of sender and/or receiver characteristics associated with a simulation. For instance, the simulation configuration manager 208 may determine various parameters and/or attributes to provide as inputs to the network behavior model 212 to use in simulating various network behaviors.

In one or more embodiments, the simulation configuration manager 208 selectively identifies one or more discrete network behaviors that the simulation engine 210 should emulate. For instance, where an administrator or app developer wishes to determine how high cross traffic or low bandwidth conditions might affect performance of an application or application update, the simulation configuration manager 208 can identify a cross traffic load and/or bandwidth metric to apply to a simulator configuration. In one or more embodiments described herein, a cross traffic load refers to a time series of values or metrics indicative of cross traffic affecting a network path over some period of time.

In one or more embodiments, the simulation configuration manager 208 may determine how to model a network path in simulating a network environment. For example, in one or more embodiments described herein, the simulation configuration manager 208 may model a network path as a single path between a sender and receiver in which the single path functions as a bottleneck having a corresponding set of network parameters. As an illustrative example, the simulation configuration manager 208 may set network parameters including a bandwidth of the modeled path, a modeled delay of the path, and a buffer size of the path. The simulation configuration manager 208 may additionally estimate a cross traffic load for the network path.

In one or more embodiments, the simulation configuration manager 208 determines the respective parameters based on sampling of the collected communication data. As an example, where the network simulation system 108 is being used to test communications between a sender and receiver under specific circumstances, the simulation configuration manager 208 may selectively sample trace data from packet traces corresponding to those specific circumstances. For example, the simulation configuration manager 208 may identify a set of senders from a first geographic location (e.g., Western United States (U.S.) associated with a first regional datacenter) and a set of receivers from a second geographic location (e.g., Eastern U.S. associated with a second regional datacenter) in which the senders and receivers are using a particular combination of applications and/or communication protocols. Other implementations may involve modeling paths between a client and a datacenter, or from any device to any other device at a different location. In this example, the simulation configuration manager 208 may sample and calculate observed bandwidths, delays, and buffer sizes for the identified sample of packet traces to use as configuration parameters.

In the above example, the simulation configuration manager 208 may selectively modify one or more parameters and/or attributes of a configuration to compare results associated with different network parameters. For example, the simulation configuration manager 208 may generate a first configuration based on a first set of attributes and/or parameters and a second configuration based on a second set of attributes and/or parameters in which one or two specific attributes or parameters are changed between the first and second configurations to enable the network simulation system 108 to compare outputs of the simulation engine 210 corresponding to the two similar configurations. Other implementations may involve randomly selecting network parameters in order to get a diverse sample size of configurations to use in accurately determining how an application, update, or protocol will function under a variety of network environments. Indeed, the simulation configuration manager 208 may identify any number of permutations of network parameters to use in determining a simulation configuration to apply to a set of input traces in accordance with one or more embodiments described herein. In one or more embodiments, network parameters may be sampled from a distribution learnt from the data.

As further shown in FIG. 2, the network simulation system 108 may include a simulation engine 210. The simulation engine 210 may be configured to run a simulation of an application or communication session in accordance with a simulation configuration. In particular, the simulation engine 210 may run a simulation in connection with a communication network 110 in which any number of network behaviors are emulated. In one or more embodiments, the simulation engine 210 simulates a single network path between a sender and receiver while emulating various network behaviors that may affect transmission of data between the sender and receiver. Alternatively, in one or more embodiments, the simulation engine 210 runs a more robust simulation for multiple network paths between any number of senders and receivers.

In one or more embodiments, the simulation engine 210 runs a simulation of a network path by applying a network behavior model 212 to a packet time series to generate a projected output at a receiver device. In particular, the simulation engine 210 may apply the network behavior model 212 trained to emulate one or more network behaviors (e.g., calculated behavior parameters, machine learned behavior parameters) in order to determine delays, packet drop rates, etc. for a given communication session between a sender and receiver. In one or more embodiments, the simulation engine 210 runs a simulation for the network assuming ideal network conditions while the network behavior model 212 simulates various network behaviors that may vary depending on characteristics of the network over time and/or characteristics of the receiver and sender.

As further shown in FIG. 2, the computing device(s) 202 may include a data storage 214. The data storage 214 may include any data used by the training system 106 and/or the simulation system 108 in training a network behavior model 212 and/or simulating a network path environment between given senders and receivers of a communication network 110. The data storage 214 may include information maintained on a single computing device (as shown in FIG. 2) or across different computing devices.

By way of example and not limitation, the data storage 214 may include network data 216 and model data 218. The network data 216 may include any information associated with a communication network 110 including topology data for networked devices that make up the communication network 110 and information about the senders and receivers on the communication network 110. The network data 216 may additionally include information obtained from packet traces derived from communications transmitted over the communication network 110. Indeed, the network data 216 may include any information used to train the network behavior model 212 as well as any information used to run a realistic simulation of the network path environment(s).

The model data 218 may include any information about the network behavior model 212. For example, the model data 218 may include algorithms and/or a machine learning model trained to output network behavior parameters usable by the network simulation system 108 to generate or refine a simulation configuration as well as emulate network behaviors on the simulation engine 210.

It will be appreciated that the components 204-212 of the computing device(s) 202 may include hardware, software, or both. For example, the components 204-212 of the training system 106 and network simulation system 108 may include one or more instructions stored on a computer-readable storage medium and executable by processors of one or more computing devices. When executed by the one or more processors, the computer-executable instructions of one or more computing devices (e.g., server device(s)) can perform one or more methods described herein. Alternatively, the components of the systems 106, 108 may include hardware, such as a special purpose processing device to perform a certain function or group of functions. Additionally, or alternatively, the components of the systems 106, 108 may include a combination of computer-executable instructions and hardware.

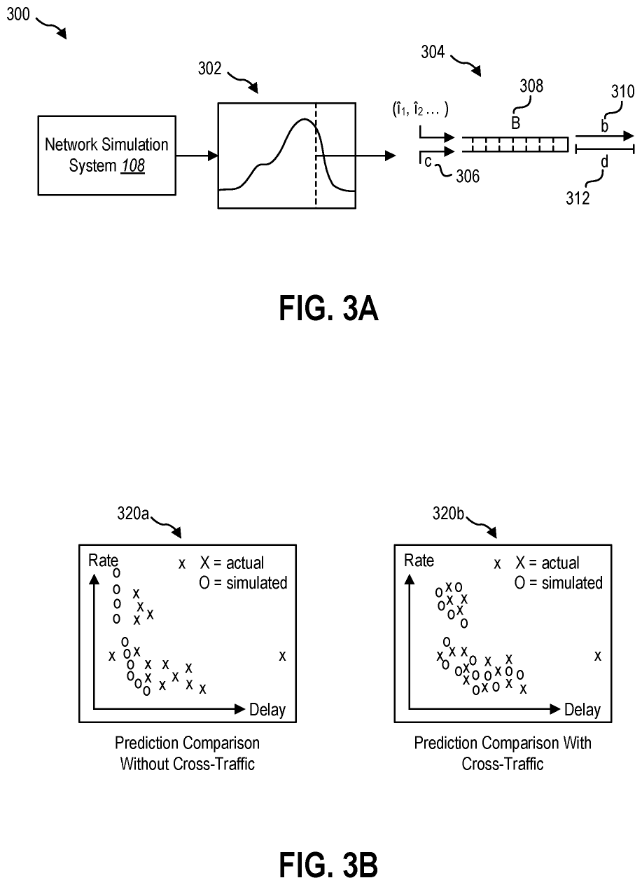

Additional detail will now be discussed in connection with an example implementation of the network simulation system 108 in which one or more calculated network behaviors are identified and emulated by a simulation engine in accordance with one or more embodiments. In particular, FIG. 3A illustrates an example workflow 300 in which a network simulation system 108 generates a time-series simulation 302. In this example, a network path 304 is modeled as a single path (e.g., a single bottleneck) between a sender and a receiver.

In one or more embodiments, the network simulation system 108 models the network path 304 over a period of time to illustrate changing network conditions and behaviors over time. FIG. 3A illustrates a sampled network path 304 at a particular point in time from the time-series simulation 302. By way of example and not limitation, the network simulation system 108 determines a cross traffic load 306 (e.g., a metric of cross traffic that affects the modeled network path), a buffer size 308 (e.g., a different between a high and low delay value), a receiving rate 310 (e.g., a peak receiving rate or bottleneck bandwidth), and a delay metric 312 (e.g., a propagation delay or minimum delay). Other implementations may model other behavior parameters in modeling a network path 304 between a sender and receiver.

The network simulation system 108 may determine the network behavior parameters in a number of ways. For example, the network simulation system 108 may determine the buffer size 306, receiving rate 310, delay metric 312 and/or other parameters by sampling data from the packet traces and determining network parameter metrics over time. The network simulation system 108 may calculate an average, median, or other composite of multiple sampled parameters to estimate how a single network path might be modeled to emulate the sampled parameters. The parameters may be determined based on sampled parameters from multiple communication sessions (e.g., from sampled communication sessions having similar characteristics). Alternatively, the parameters may refer to observed parameters for a single communication session from the data collected from the communication network 110.

With respect to the estimated cross traffic load, the network simulation system 108 may estimate or otherwise determine the cross-traffic load in a variety of ways. In one or more embodiments, the network simulation system 108 observes one or more of the above metrics 306-312 and estimates cross traffic based on one or more of the observed behavior metrics. For example, the network simulation system 108 can compare a delay of two packets from a communication. Knowing the size of the queue (e.g., the buffer size) and the flow rate of the queue, the network simulation system 108 can compare the queue occupancy at two times, as observed by packets, to determine a measure of cross traffic that enters the queue between the respective packets. In one or more embodiments, the network simulation system 108 estimates a cross traffic load (Cₑₛₜ) in accordance with the following formula:

Cₑₛₜ={Q(k)−Q(k−n)+DrainTime*b−Σsᵢ}/Στᵢ

where Q refers to queue occupancy estimated at a k^{th} packet, DrainTime refers to the time for which the queue has been draining, Σsᵢ refers to a sum of all packet sizes from the (k−n)^{th} to the k^{th}, and Στᵢ refers to a sum of all inter packet times in the window. In one or more embodiments, the DrainTime specifically refers to a time when a buffer of the modeled bottleneck path is non-empty and is therefore draining at the peak capacity of the bottleneck link.

The addition of the cross-traffic load enables the network simulation system 108 to output more accurate results. In particular, by considering a combination of the sampled network parameters of buffer size 306, receiving rate 308, and delay metric, the network simulation system 108 can provide estimated delays for a packet time series that provides a general estimate for how data will be transmitted between a given sender and receiver having a corresponding set of characteristics. Adding the cross-traffic metric 304, however, causes the resulting estimation to more accurately resemble real results on the communication network 110 for a variety of protocols and applications.

FIG. 3B illustrates example result sets 320a-b showing a comparison of ground truth data and estimated data using the network simulation system 108 in accordance with one or more embodiments described above. In particular, a first result set 320a shows an example in which the cross-traffic load is not included. The figure plots the delay and rate values for the individual flows, with each circle (estimated through simulation) or cross (ground truth) corresponding to a single flow. As shown in FIG. 3B, the delay tends to be underestimated relative to the ground truth.

In contrast, a second result set 320b shows the same set of actual delay results and a different set of estimated delay results shown on a similar graph in which the cross-traffic metric is considered in accordance with one or more embodiments described above. In this example, the estimated results of the second result set 320b are much closer to the actual results than the first result set 320a in which the cross-traffic metric is not considered.

As mentioned above, in one or more embodiments, the training system 106 trains a network behavior model 212 including a machine learning model that is trained to emulate one or more network behaviors. In particular, in one or more embodiments, the network behavior model 212 may be trained to emulate one or more machine-learned behaviors including, by way of example, reordering of network packets from a packet time series, variable bandwidth over a duration of time, and random loss of network packets from the packet time series. Indeed, the network behavior model 212 may be trained to emulate any number of network behaviors that can be learned based on a collection of packet traces from observed communications on the communication network 110.

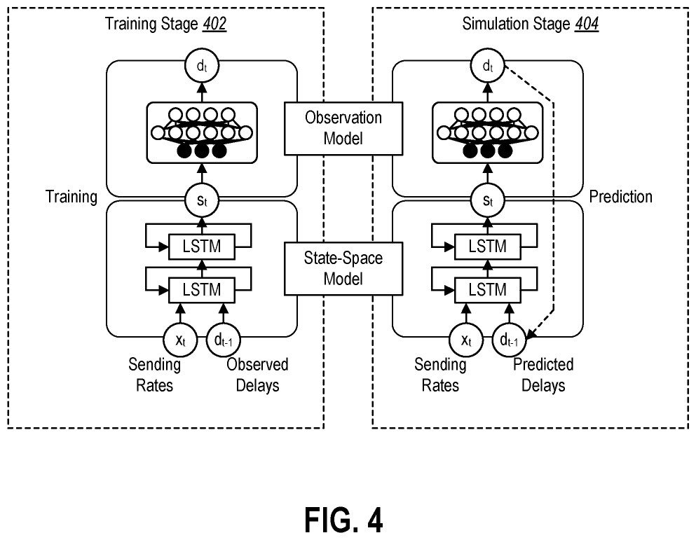

FIG. 4 illustrates an example implementation showing a training stage 402 and simulation stage 404 for training and implementing a machine learning model in accordance with one or more embodiments. The training stage 402 and simulation stage 404 shown in FIG. 4 is an example implementation of the training stage 102 and simulation stage 104 discussed above in connection with FIG. 1. Moreover, the training stage 402 and simulation stage 404 involving training and implementing a machine learning model may be combined with features and functionality discussed above in connection with FIG. 3A in which one or more behavior parameters are determined and estimated without the use of a machine learning model.

It will be appreciated that the network behavior model 212 may include a variety of machine learning models. As an example, FIG. 4 shows an implementation in which the network behavior model 212 includes a deep long short term memory (LSTM) neural network. In this example, a training stage 402 may be implemented in which delays for communications are observed between senders and receivers on the communication network 110. Once trained, a simulation stage 404 may be implemented in which the LSTM neural network is used to predict delays between senders and receivers on the communication network 110.

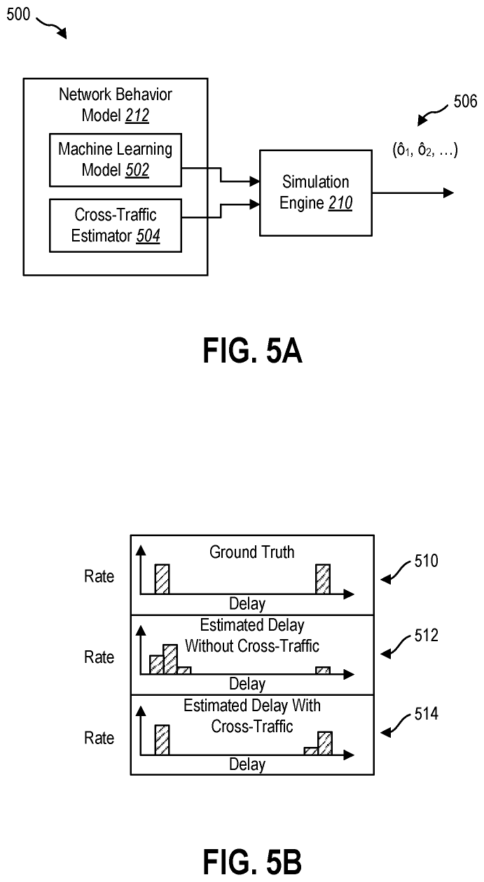

As noted above, in one or more embodiments, the network behavior model 212 may be implemented as a combination of a machine learning model and one or more algorithms that do not necessarily employ machine learned algorithms. In particular, FIG. 5A illustrates an example in which a network behavior model 212 is used to emulate a combination of machine-learned and sampled behaviors in accordance with one or more embodiments.

More specifically, FIG. 5A illustrates an example implementation in which the network behavior model 212 includes a machine learning model 502 that learns one or more machine learned behaviors such as reordering of network packets, variable bandwidth, and random loss of network packets. In addition to the machine learning model 502, the network behavior model 212 may include a cross-traffic estimator 504 that estimates a cross traffic load in accordance with one or more embodiments discussed above. As shown in FIG. 5A, the simulation engine 210 may simulate sending and receiving communications between a sender and receiver while emulating one or more machine learned behaviors and cross-traffic to generate a predicted output 506 including a predicted delay for an input packet time series.

While FIG. 5A illustrates an example in which a particular combination of network behaviors are emulated by the network simulation system 108, it will be understood that various combinations of network behaviors discussed herein may be similarly implemented. For example, in one or more embodiments, the network simulation system 108 my identify or otherwise receive only machine-learned parameters (e.g., re-ordering of packets, variable bandwidth, etc.) or, alternatively, sampled parameters (e.g., bandwidth, delay, cross-traffic metrics, etc.).

In combination with one or more machine learned parameters, a simulation engine 210 may receive a cross-traffic metric in accordance with one or more embodiments described above. Thus, as shown in FIG. 5A, a network simulation system can generate a predicted output 506 showing a predicted delay for an input packet time series.

Similar to one or more embodiments discussed above in connection with FIGS. 3A-3B, inclusion of a cross traffic load can similarly improve upon the accuracy of output estimations based on machine-learned network behaviors. For example, FIG. 5B illustrates a comparison of predicted outputs in which different combinations of network behavior characteristics have been applied to the simulation configuration.

As shown in FIG. 5B, a first result set 510 illustrates a ground truth set in which actual delay results are mapped against a frequency percentage. In this example, the tracked delays are grouped in two groupings associated with normal and low delay scenarios. A second result set 512 illustrates delay predictions without considering cross-traffic metrics. In this example, the machine learning model may have erroneously introduced control loop bias as a result of interpreting the low delay scenarios as implying a high sending rate. As a result, the estimated delay output for an input packet time series underestimates the delay of the packet time series.

In accordance with one or more embodiments described herein, the training system 106 and network simulation system 108 can incorporate a cross traffic load and infer that the low delay scenarios do not necessarily imply a high sending rate. As a result, the third result set 514 includes a much more accurate set of delay predictions that more closely resemble the ground truth data from the first result set 510.

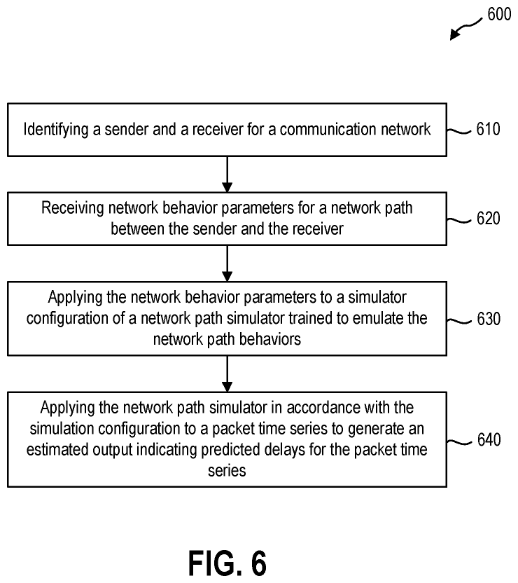

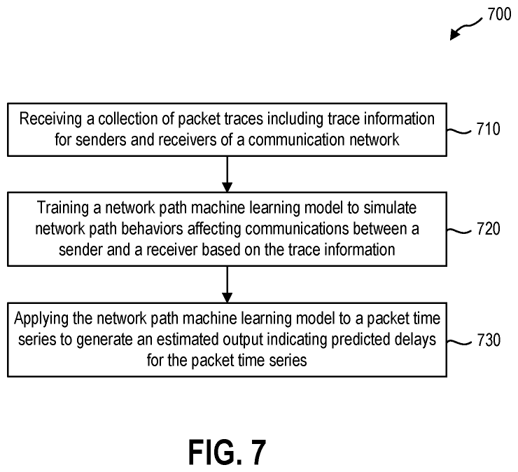

Turning now to FIGS. 6-7, these figures illustrate an example flowchart including a series of acts for training and implementing a simulation configuration that models various network behaviors in accordance with one or more embodiments. While FIGS. 6-7 illustrate acts according to one or more embodiments, alternative embodiments may omit, add to, reorder, and/or modify any of the acts shown in FIGS. 6-7. The acts of FIGS. 6-7 can be performed as part of a method. Alternatively, a non-transitory computer-readable medium can include instructions that, when executed by one or more processors, cause a computing device (e.g., a server device) to perform the acts of FIGS. 6-7. In still further embodiments, a system can perform the acts of FIGS. 6-7.

FIG. 6 shows a series of acts 600 related to training and implementing a simulation configuration in accordance with one or more embodiments described herein. As shown in FIG. 6, the series of acts 600 includes an act 610 of identifying a sender and a receiver for a communication network. For example, in one or more embodiments, the act 610 includes identifying a sender and a receiver within a communication network, the sender being associated with a first set of attributes and the receiver being associated with a second set of attributes.

As further shown, the series of acts 600 includes an act 620 of receiving network behavior parameters for a network path between the sender and the receiver. For example, in one or more embodiments, the act 620 includes receiving one or more network behavior parameters for a network path between the sender and the receiver, the one or more network behavior parameters including an estimated cross traffic load associated with an estimated volume of cross traffic from additional senders and receivers within the communication network.

As further shown, the series of acts 600 may include an act 630 of applying the network behavior parameters to a simulator configuration of a network path simulator trained to emulate the network path behaviors. For example, in one or more embodiments, the act 630 includes applying the network behavior parameters to a simulator configuration of a network path simulator, the network path simulator being trained to emulate network behavior based on the simulator configuration.

As further shown, the series of acts 600 includes an act 640 of applying the network path simulator in accordance with the simulation configuration to a packet time series to generate an estimated output indicating predicted delays for the packet time series. For example, in one or more implementations, the act 640 includes applying the network path simulator in accordance with the simulator configuration to a packet time series to generate an estimated output for the packet time series via the network path environment between the sender and the receiver.

In one or more embodiments, the one or more network parameters include one or more sampled parameters from a collection of network traces derived from previous communications between a plurality of senders and a plurality of receivers within the communication network. In addition, in one or more embodiments, the first set of attributes and the second set of attributes include one or more of types of connectivity, locations of the sender and receiver, and Internet service provider (ISP) identifiers associated with the sender and the receiver. Further, in one or more embodiments, the one or more network behavior parameters includes selectively sampled parameters from the collection of network traces associated with one or more communications between the corresponding sender and receiver.

In some implementations, the one or more network behavior parameters includes the estimated cross traffic load and one or more behavior parameters for a modeled path between the sender and receiver. The one or more network parameters may include one or more of a bandwidth of the modeled path, a modeled delay for the modeled path, and a buffer size of the modeled path. In one or more embodiments, the network path simulator is configured to model the network path environment as a single bottleneck path between the sender and the receiver. In one or more embodiments, the series of acts 600 includes determining the estimated cross traffic load based on sampled behavior data between one or more senders and corresponding receivers.

In one or more embodiments, receiving the one or more network behavior parameters includes randomly sampling a collection of network traces between a plurality of senders and a plurality of receivers. Receiving the parameters may also include learning the one or more network behavior parameters for the network path environment based on the randomly sampled network traces. In one or more embodiments, receiving the behavior parameters includes selectively sampling network traces between a plurality of senders and a plurality of receivers. In one or more embodiments, receiving the behavior parameters includes learning the one or more network behavior parameters for the network path based on the selectively sampled network traces.

FIG. 7 illustrates an example implementation of a series of acts 700 related to training and implementing a simulation configuration in accordance with one or more embodiments described herein. As shown in FIG. 7, the series of acts 700 may include an act 710 of receiving a collection of packet traces including trace information for senders and receivers of a communication network. In one or more embodiments, the act 710 includes receiving a collection of packet traces for a plurality of communications between a set of senders and a corresponding set of receivers. In one or more embodiments, the trace information includes a first set of attributes for the set of senders and a second set of attributes for the set of receivers, and wherein the network path machine learning model is further trained based on the first set of attributes and the second set of attributes.

As further shown, the series of acts 700 includes an act 720 of training a network path machine learning model to simulate network path behaviors affecting communications between a sender and a receiver based on the trace information. For example, in one or more embodiments, the act 720 includes training a network path machine learning model to simulate network behavior parameters affecting communications between a given sender and a given receiver based on trace information derived from the collection of packet traces for the plurality of communications between the set of senders and the corresponding set of receivers.

As further shown, the series of acts 700 includes an act 730 of applying the network path machine learning model to a packet time series to generate an estimated output indicating predicted delays for the packet time series. For example, in one or more embodiments, the act 730 includes applying the network path machine learning model to a packet time series associated with a sender to generate an estimated output for the packet time series via a network path between the sender and a receiver.

In one or more embodiments, the network path machine learning model includes a deep long short term memory (LSTM) neural network trained to predict delay for communications between the given sender and the given receiver. In one or more embodiments, the network path machine learning model is trained to predict network behavior parameters including one or more of reordering of network packets from the packet time series, variable bandwidth over a duration associated with the packet time series, and/or random loss of network packets from the packet time series.

In one or more embodiments, the series of acts 700 includes estimating a cross traffic load based on sampled behavior data between one or more senders from the set of senders and one or more receivers from the set of receivers and providing the cross traffic load to the network path machine learning model as an estimated behavior of the network path between the sender and the receiver. In one or more embodiments, estimating and providing the cross-traffic load is based on detected instances of high sending rates from the packet time series.

In accordance with one or more embodiments, the one or more network parameters may include one or more sampled parameters from a collection of network traces derived from previous communications between a plurality of senders and a plurality of receivers within the communication network. In one or more embodiments, the one or more network behavior parameters include one or more machine-learned parameters output by a network path machine learning model trained, the machine learning model being trained to output one or more predicted network behavior parameters.

FIG. 8 illustrates certain components that may be included within a computer system 800. One or more computer systems 800 may be used to implement the various devices, components, and systems described herein.

The computer system 800 includes a processor 801. The processor 801 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 7 as a bus system 819.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular datatypes, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method, comprising:
identifying a sender and a receiver within a communication network, the sender being associated with a first set of attributes and the receiver being associated with a second set of attributes;
receiving one or more network behavior parameters for a network path between the sender and the receiver, the one or more network behavior parameters including an estimated cross-traffic load associated with sampled behavior data from additional senders and corresponding receivers within the communication network;
generating a simulated communication network utilizing a network path simulator by providing a simulator configuration based on the estimated cross-traffic load to the network path simulator; and
generating an estimated output for a packet time series sent between the sender and the receiver via the network path utilizing the simulated communication network generated by the network path simulator in accordance with the simulator configuration.

2. The method of claim 1, further comprising generating the estimated cross-traffic load based on the one or more network behavior parameters comprising a buffer size, a receiving rate, and a delay metric between two or more packets.

3. The method of claim 1, wherein the first set of attributes and the second set of attributes include one or more of types of connectivity, locations of the sender and the receiver, and Internet service provider (ISP) identifiers associated with the sender and the receiver.

4. The method of claim 3, wherein the one or more network behavior parameters includes selectively sampled parameters from a collection of network traces associated with one or more communications between the sender and the receiver.

5. The method of claim 1, wherein the one or more network behavior parameters includes the estimated cross-traffic load and one or more behavior parameters for a modeled path between the sender and the receiver, the one or more behavior parameters including one or more of:
a bandwidth of the modeled path;
a modeled delay for the modeled path; or
a buffer size of the modeled path.

6. The method of claim 1, wherein the network path simulator is configured to model the network path as a single bottleneck path between the sender and the receiver.

7. The method of claim 6, further comprising determining the estimated cross-traffic load based on sampled behavior data between one or more senders and one or more corresponding receivers.

8. The method of claim 1, wherein receiving the one or more network behavior parameters includes:
randomly sampling a collection of network traces between a plurality of senders and a plurality of corresponding receivers; and
learning the one or more network behavior parameters for the network path based on the randomly sampled network traces.

9. The method of claim 1, wherein receiving the one or more network behavior parameters includes:
selectively sampling network traces between a plurality of senders and a plurality of corresponding receivers; and
learning the one or more network behavior parameters for the network path based on the selectively sampled network traces.

10. A method for configuring a network path simulator, comprising:
receiving a collection of packet traces for a plurality of communications between a set of senders and a corresponding set of receivers;
estimating a cross-traffic load based on sampled behavior data between one or more senders from the set of senders and one or more corresponding receivers from the corresponding set of receivers;
generating a network path machine learning model that simulates network behavior parameters affecting communications between a given sender and a given receiver based on trace information derived from the collection of packet traces for the plurality of communications and the cross-traffic load; and
generating an estimated output for a packet time series sent from a sender to a receiver via a network path utilizing the network path machine learning model.

11. The method of claim 10, wherein the network path machine learning model includes a deep long short term memory (LSTM) neural network trained to predict a communication delay between the given sender and the given receiver.

12. The method of claim 10, wherein estimating the cross-traffic load is based on determining a delay of packets by comparing a queue size of a queue and a queue flow rate of the queue with respect to the packets.

13. The method of claim 10, wherein estimating the cross-traffic load is based on detected instances of high sending rates from the packet time series.

14. The method of claim 10, wherein the network path machine learning model is trained to predict the network behavior parameters including one or more of:
reordering of network packets from the packet time series;
variable bandwidth over a duration associated with the packet time series; or
random loss of the network packets from the packet time series.

15. The method of claim 10, wherein the trace information includes a first set of attributes for the set of senders and a second set of attributes for the corresponding set of receivers, and wherein the network path machine learning model is further trained based on the first set of attributes and the second set of attributes.

16. A system, comprising:
one or more processors;
memory in electronic communication with the one or more processors; and
instructions stored in the memory, the instructions being executable by the one or more processors to:
identify a sender and a receiver within a communication network, the sender being associated with a first set of attributes and the receiver being associated with a second set of attributes;
receive one or more network behavior parameters for a network path between the sender and the receiver, the one or more network behavior parameters including an estimated cross-traffic load associated with sampled behavior data from additional senders and corresponding receivers within the communication network;
generate a simulated communication network utilizing a network path simulator by providing a simulator configuration based on the estimated cross-traffic load to the network path simulator; and
generate an estimated output for a packet time series via the network path between the sender and the receiver by utilizing the network path simulator having the modified simulator configuration and the packet time series.

17. The system of claim 16, wherein the one or more network behavior parameters include one or more sampled parameters from a collection of network traces derived from previous communications between a plurality of senders and a plurality of corresponding receivers within the communication network.

18. The system of claim 17, wherein the one or more network behavior parameters include one or more machine-learned parameters output by a network path machine learning model, the network path machine learning model being trained to generate one or more predicted network behavior parameters.

19. The system of claim 17, wherein the network path simulator is configured to model the network path as a single bottleneck path between the sender and the receiver.

20. The system of claim 19, further comprising instructions being executable by the one or more processors to determine the estimated cross-traffic load based on sampled behavior data between one or more senders and one or more corresponding receivers during a time when a buffer of the single bottleneck path is draining at a peak capacity.
